(19) United States
(12) Patent Application Publication
(10) Pub. No.: US 2026/0291338 A1
(43) Pub. Date: Sep. 24, 2026

(54) DRIVE AXLE FOR AN ELECTRIC VEHICLE

(71) Applicant: ZF FRIEDRICHSHAFEN AG, Friedrichshafen (DE)

(72) Inventors: Joao BONIFACIO, Meckenbeuren (DE); Jörg BENDER, Würzburg (DE); Philipp NEIDHARDT, Markdorf (DE); Philipp KRAFT, Würzburg (DE); Michael TRAUT, Bergrheinfeld (DE); Alexander BÜTTNER, Sulzthal (DE); Tobias DIECKHOFF, Würzburg (DE)

(21) Appl. No.: 19/474,069

(22) PCT Filed: Apr. 12, 2024
(86) PCT No.: PCT/EP2024/059941

§ 371 Date: Oct. 9, 2025

(30) Foreign Application Priority Data
Apr. 13, 2023 (DE) 10 2023 203 360.7

(51) Int. Cl. H02K 11/00; H02K 7/00; H02K 13/00; H02K 19/38

(52) U.S. Cl. CPC H02K 11/0094; H02K 7/003; H02K 7/006; H02K 13/003; H02K 19/38

(57) ABSTRACT

A drive axle for an electric vehicle, having a transmission and an electric motor formed as a separately excited synchronous machine having a rotor, a stator, an excitation unit, and a hollow rotor shaft with an outer diameter. The electric motor is coupled to the transmission via the hollow rotor shaft. The excitation unit is arranged inside of the rotor shaft and comprises an exciting part, which is formed so as to be static and not rotating with the rotor shaft, and an excited part which is fixedly connected to the rotor shaft and rotates along with it. In order to facilitate installation of the excitation unit inside the rotor shaft, the rotor shaft is formed of two parts with a first rotor shaft part and a second rotor shaft part, and the excitation unit is located in the first rotor shaft part.

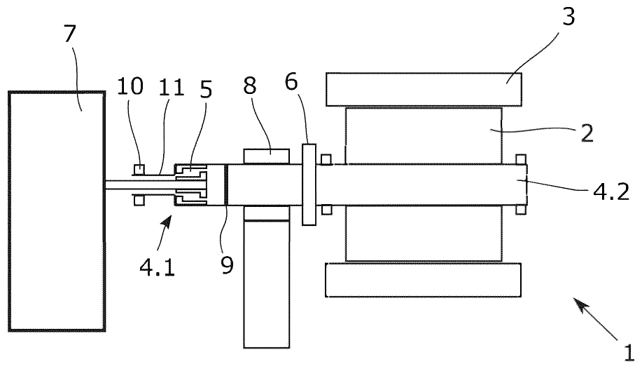

### CROSS REFERENCE TO RELATED APPLICATIONS

This is a U.S. national stage of Application No. PCT/EP2024/059941 filed Apr. 12, 2024. Priority is claimed on German Patent Application No. DE 10 2023 203 360.7 filed Apr. 13, 2023, the contents of which are incorporated herein by reference.

### BACKGROUND OF THE INVENTION

### 1. Field of the Invention

The disclosure is directed to a drive axle for an electric vehicle, comprising a transmission, an electric motor formed as a separately excited synchronous machine having a rotor, a stator, an excitation unit and a hollow rotor shaft with an outer diameter. The electric motor is coupled to the transmission via the hollow rotor shaft. The excitation unit is arranged inside of the rotor shaft and comprises an exciting part which is not connected to the rotor shaft and an excited part which is fixedly connected to the rotor shaft.

### 2. Description of the Related Art

An important aspect in the development of electric drive axles for electric vehicles or hybrid vehicles is to make them as compact and efficient as possible. Therefore, an installation space required for the drive should be as small as possible. Beyond this, it makes sense for the efficiency of such an electric drive axle to arrange and connect the components in such a way that current, mechanical forces, and torques have to travel as short a distance as possible.

In prior art electric drive axles for passenger cars, permanent magnet synchronous motors (PMSM) or separately excited synchronous motors (SESM) are principally used as drives. Whereas permanent magnet excited synchronous motors have permanent magnets in the rotor for generating a magnetic field, separately excited synchronous motors have windings in the rotor through which a current is conducted to generate the magnetic field. The latter is advantageous in that a strength of the magnetic field can be adjusted by a current intensity and that no rare earths are required for the permanent magnets, which is why this technology plays a particularly important role in reducing production costs.

Separately excited synchronous motors generally have a stator and a rotor which has a rotor shaft and can rotate around a rotor axis. In the prior art, the power electronics are generally arranged behind the rotor and/or transmission in radial direction as seen from the rotor axis, which takes up additional installation space in radial direction. The power electronics further comprise an inverter that converts the DC voltage supplied by a vehicle battery into AC voltage which is used to excite the motor.

It is known from practice to arrange the excitation unit inside of the rotor shaft in order to support the centrifugal forces that occur and to gain more installation space. The rotor shaft is usually constructed integrally and is closed by a rotor shaft journal which is received completely by the rotor shaft. On the one hand, this makes it difficult to insert the excitation unit; on the other hand, the diameter of the rotor shaft depends on the dimensions of the excitation unit, which it usually exceeds, so that larger bearings must be used accompanied by higher losses and costs, especially if bearings have to be used that do not correspond to the standard sizes.

### SUMMARY OF THE INVENTION

Therefore, it is the object of one aspect of the invention to adapt a drive axle with an electric motor formed as a separately excited synchronous machine such that the installation of the excitation unit is facilitated.

The above-stated object is met in the drive axle described at the beginning in that the rotor shaft is formed of two parts with a first rotor shaft part and a second rotor shaft part, and the excitation unit is located in the first rotor shaft part. In this way, the interior of the rotor shaft is easily accessible via the connection end of one of the rotor shaft parts before the first rotor shaft part and second rotor shaft part are joined together via a respective connecting end. Therefore, the ends of the rotor shafts, one of which is used to access the interior of the rotor shaft in a one-piece rotor shaft, can be constructed with a smaller diameter suitable for the bearings. After the excitation unit has been inserted into the first rotor shaft part, the first rotor shaft part and second rotor shaft part are connected to one another at their connection ends, forming a connection region, and the rotor shaft is integrated in the drive axle of an electric vehicle.

In an advantageous implementation, the exciting part and the excited part comprise ferrite, SMC, or another ferromagnetic material. Such an inductive excitation unit is particularly advantageous for installation inside of the rotor shaft.

It is further advantageous when an insulator is arranged between the first rotor shaft part and second rotor shaft part, which insulator electrically insulates the rotor shaft parts from one another. In this way, circular currents which are induced on the rotor shaft by a typically high-frequency timing of the inverter can be reduced.

In a further advantageous implementation, the first rotor shaft part and second rotor shaft part are connected via a spline or welded to one another. In this way, the rotor shaft parts are fixedly connected to one another.

It is further advantageous when at least the first rotor shaft part has a stepped end with a smaller outer diameter than the outer diameter of the rotor shaft, and the stepped end forms a bearing seat. This allows the bearings supporting the rotor shaft to be constructed smaller or, in general, the outer diameter of the rotor shaft to be adapted to a desired diameter regardless of the diameter of the installation space required for the excitation unit.

It is further advantageous to integrate such a drive axle in an electric drive system for a vehicle or in an electric vehicle.

It is understood that the features mentioned above and those yet to be explained below can be used not only in the stated combinations, but also in other combinations or alone, without departing from the scope of the present invention.

### BRIEF DESCRIPTION OF THE DRAWINGS

The invention will be described in more detail in the following with reference to an embodiment example and the accompanying drawing which also discloses key features of the invention. This embodiment example is merely illustrative and should not be construed as limiting. Rather, other embodiment examples may also include alternative elements and components, fewer elements or components, or additional elements or components. The drawing shows:

The Figure is a schematic representation of a drive axle.

### DETAILED DESCRIPTION OF THE PRESENTLY PREFERRED EMBODIMENTS

The Figure shows a drive axle such as it can be incorporated in an electric drive system of a vehicle or an electric vehicle. Located at the drive axle is an electric motor 1 which is formed as a separately excited synchronous motor and comprises a rotor 2 and a stator 3. Further, the electric motor 1 comprises a rotor shaft comprising a first rotor shaft part 4.1 and a second rotor shaft part 4.2. An excitation unit 5 is arranged inside the rotor shaft, and a rotor position sensor 6 is arranged at the rotor shaft. The excitation unit and the rotor position sensor 6 are connected to power electronics 7 that drive the electric motor 1. The torque generated at the rotor shaft is transmitted via a transmission 8 to an output, not shown, of the drive axle.

The excitation unit 5 has a static exciting part that does not rotate with the rotor shaft and is not connected to the rotor shaft. In this example, it is connected to the power electronics 7 via a shaft that projects into the first rotor shaft part 4.1. On the inside of the first rotor shaft part 4.1 is an excited part of the excitation unit 5 that is connected to the rotor shaft and correspondingly rotates together with the first rotor shaft part 4.1.

In this regard, an inductive excitation unit 5 and a conductive excitation unit 5 can both be used without problems. In this case, a conductive excitation unit 5 comprising a plurality of sliding elements or transmission elements and contacts can be constructed such that the transmission elements or sliding elements are arranged as exciting part at the shaft projecting into the first rotor shaft part 4.1 and are electrically connected to contacts. The latter are located directly opposite the exciting part at an inner side of the first rotor shaft part 4.1 and form the excited part of the excitation unit 5. If the excitation unit 5 is constructed as an inductive excitation unit 5 as in the depicted embodiment example, i.e., formed of two ferromagnetic components, the excited part is arranged at the inner side of the first rotor shaft part 4.1 and the exciting part is arranged at the shaft projecting into the first rotor shaft part 4.1.

Located between the first rotor shaft part 4.1 and the second rotor shaft part 4.2 is a connection region 9 where the two rotor shaft parts 4.1, 4.2 are joined together. This can be effected in various ways, but a splining or welding of the rotor shaft parts 4.1, 4.2 is preferred.

The rotor shaft is bearing-supported at a plurality of points. A bearing 10 is likewise provided at the first rotor shaft part 4.1 where it is, however, seated at a stepped end 11 of the first rotor shaft part 4.1. The stepped end 11 has a smaller outer diameter than the rotor shaft. It is generally also possible to form the second rotor shaft part 4.2 with a second stepped end at which a further bearing is located in turn.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A drive axle for an electric vehicle, comprising:
a transmission; and
an electric motor formed as a separately excited synchronous machine having:
a rotor shaft that is formed in two parts with a first rotor shaft part and a second rotor shaft part;
a rotor;
a stator;
a hollow rotor shaft with an outer diameter, and configured to couple the electric motor to the transmission; and
an excitation unit arranged inside of the first rotor shaft part and comprises an exciting part which is not connected to the rotor shaft and an excited part which is fixedly connected to the rotor shaft.

9. The drive axle according to claim 8, wherein the exciting part and the excited part comprise ferrite, SMC, or another ferromagnetic material.

10. The drive axle according to claim 8, further comprising:
an insulator arranged between the first rotor shaft part and second rotor shaft part, configured to electrically insulate the first and second rotor shaft parts from one another.

11. The drive axle according to claim 8, wherein the first rotor shaft part and second rotor shaft part are connected via a spline or are welded together.

12. The drive axle according to claim 8, wherein at least the first rotor shaft part has a stepped end with a smaller outer diameter than the outer diameter of the rotor shaft, and the stepped end forms a bearing seat.

13. An electric drive system for a vehicle comprising:
a drive axle, comprising:
a transmission; and
an electric motor formed as a separately excited synchronous machine having:
a rotor shaft that is formed in two parts with a first rotor shaft part and a second rotor shaft part;
a rotor;
a stator;
a hollow rotor shaft with an outer diameter, and configured to couple the electric motor to the transmission; and
an excitation unit arranged inside of the first rotor shaft part and comprises an exciting part which is not connected to the rotor shaft and an excited part which is fixedly connected to the rotor shaft.

14. An electric vehicle comprising:
a drive axle, comprising:
a transmission; and
an electric motor formed as a separately excited synchronous machine having:
a rotor shaft that is formed in two parts with a first rotor shaft part and a second rotor shaft part;
a rotor;
a stator;
a hollow rotor shaft with an outer diameter, and configured to couple the electric motor to the transmission; and
an excitation unit arranged inside of the first rotor shaft part and comprises an exciting part which is not connected to the rotor shaft and an excited part which is fixedly connected to the rotor shaft.
